(19) United States
(12) Patent Application Publication
(10) Pub. No.: US 2003/0068142 A1
(43) Pub. Date: Apr. 10, 2003

(54) Optical subassembly for fiber arrays with a 90 degree conductor turn

(76) Inventors: Johnny Roy Brezina, Austin, TX (US); Mitchell Simmons Cohen, Bedford, MA (US); Brian Michael Kerrigan, Austin, TX (US); Gerald Daniel Malagrino JR., Rochester, MN (US)

Correspondence Address: Duke W. Yee, Carstens, Yee & Cahoon, L.L.P., P.O. Box 802334, Dallas, TX, 75380, US

(21) Appl. No.: 10/177,198

(22) Filed: Jun. 21, 2002

Related U.S. Application Data
(62) Division of application No. 09/791,151, filed on Feb. 22, 2001.

(51) Int. Cl. G02B 6/42

(52) U.S. Cl. 385/92; 385/88

(57) ABSTRACT

An optical subassembly is provided. A mounting structure having a plurality of angled conductive traces is disposed on a first surface of the mounting structure. A holding device, coupled to a second surface of the mounting structure, has a plurality of optical channels. A laser optical device is electrically connected to the conductive traces on the mounting structure. An optical signal is emitted or received by the laser optical device and is converted to an electrical signal. The electrical signal is transmitted by way of the plurality of angled conductive devices to the plurality of optical channels.

### BACKGROUND OF THE INVENTION

1. Technical Field

The present invention relates to an improved data processing system and in particular to a method and apparatus for transmitting data. Still more particularly, the present invention relates to a method and apparatus for managing transmission of data from a source to a destination.

2. Description of the Related Art

To conserve space in optoelectronic packaging it is necessary to place optical fibers delivering the signals in a plane nearly coincident with the plane of an electronic board on which a transmitter, receiver, or transceiver module is based. A vertical cavity surface emitting laser (VCSEL) is a laser less than half the width of a human hair that emits light in a cylindrical beam from its surface and offers several advantages over edge-emitting lasers. VCSELs are smaller than edge-emitting lasers, are cheaper to manufacture, as they use the same fabrication techniques as chips, offer greater reduced power consumption and can be packaged closely together in two-dimensional arrays.

However, a recurring packaging problem is presented by the fact that light impinges on the face of receiver chips and light is emitted from the face of VCSEL chips. If these optoelectronic chips are mounted on the electronic board, the light paths associated with these optoelectronic chips are perpendicular to the axes of the fibers. These problems are exacerbated as the data rates increase and, consequently, the electrical path lengths are required to decrease. Therefore, it would be advantageous to have a method and system for fabricating an optical subassembly (OSA) associated with a transmitting or receiving function by using a special optoelectronic submount incorporating a 90 degree turn for a multiple channel fiber array so that each transmission and reception carries an array of VCSELs and an array of photodetectors, respectively.

### SUMMARY OF THE INVENTION

The present invention provides an optical subassembly. A mounting structure having a plurality of angled conductive traces is disposed on a first surface of the mounting structure. A holding device, coupled to a second surface of the mounting structure, has a plurality of optical channels. A laser optical device is electrically connected to the conductive traces on the mounting structure. An optical signal is emitted or received by the laser optical device and is converted to an electrical signal. The electrical signal is transmitted by way of the plurality of angled conductive devices to the plurality of optical channels.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is an exemplary illustration of a fiber optic holder/submount assembly after insertions of the fiber holder into the submount in accordance with a preferred embodiment of the present invention;

FIG. 2 is an exemplary illustration of a manufacturing process used in the fabrication of a silicon submount to be processed in wafer form in accordance with a preferred embodiment of the present invention;

FIG. 3 is an exemplary illustration of a completed submount designed to accept an optoelectronic chip in accordance with a preferred embodiment of the present invention;

FIG. 4 is an exemplary illustration of flip chip bonding of an optoelectronic chip on a submount in accordance with a preferred embodiment of the present invention;

FIG. 5 is an exemplary illustration of a submount designed for flip-chip mounting of an optoelectronic chip in accordance with a preferred embodiment of the present invention;

FIG. 6 is an exemplary illustration of using a precision flip-chip die bonder to obtain passive alignment with an optoelectronic submount in accordance with a preferred embodiment of the present invention;

FIG. 7 is an exemplary illustration of a submount to be used with a fiber optic array in accordance with a preferred embodiment of the present invention;

FIG. 8 is an exemplary illustration of a fiber optic end holder structure designed to mate with a submount in accordance with a preferred embodiment of the present invention;

FIG. 9 is an exemplary illustration of a fully assembled submount with fiber optic holder and optoelectronic chips in accordance with a preferred embodiment of the present invention; and

FIG. 10 is an exemplary illustration of a finished assembly of the fully assembled submount with fiber optic holder and optoelectronic chips incorporated into a circuit board in accordance with a preferred embodiment of the present invention.

### DETAILED DESCRIPTION

The present invention provides a method and system for fabricating an optical subassembly (OSA) associated with a transmitting or receiving function by using a special optoelectronic submount incorporating a 90 degree turn for a multiple channel fiber array so that each transmission and reception carries an array of VCSELs and an array of photodetectors, respectively. The packaging problem noted above may be solved by either mounting the chips in the plane of the board and bending the optical path between the chips and the fibers by 90 degrees or, alternatively, by mounting the chips perpendicular to the plane of the board and bending the electrical path between the chips and the board by 90 degrees.

The optical bend method presents an optical design problem and the component(s) used for the bending can be expensive and difficult to fabricate. The electrical bend method for optoelectronic packaging involves the use of a flexible circuit. However, flexible material used to construct the flexible circuit is costly and is often difficult to handle in very confined spaces. In the present invention, electrical bending is employed with the added feature that each optoelectronic chip is mounted on a submount which may incorporate electrical traces that provide a built-in 90 degree turn. Prior art submounts containing electrical traces with a built-in 90 degree turn are improved with the present invention by allowing a large number of submounts to be fabricated in parallel on a silicon wafer by use of photolithography. In addition, dimension of electrical traces on the submount may be controlled precisely by the use of photolithography. Photolithography is a process of transferring geometric shapes on a mask to a silicon wafer.

Furthermore, the material, such as, for example, silicon used for the submount provides a higher level of heat dissipation from the optoelectronic chip and permits fabrication of active devices on the submount if desired. Features may be etched into the submount to aid in packaging.

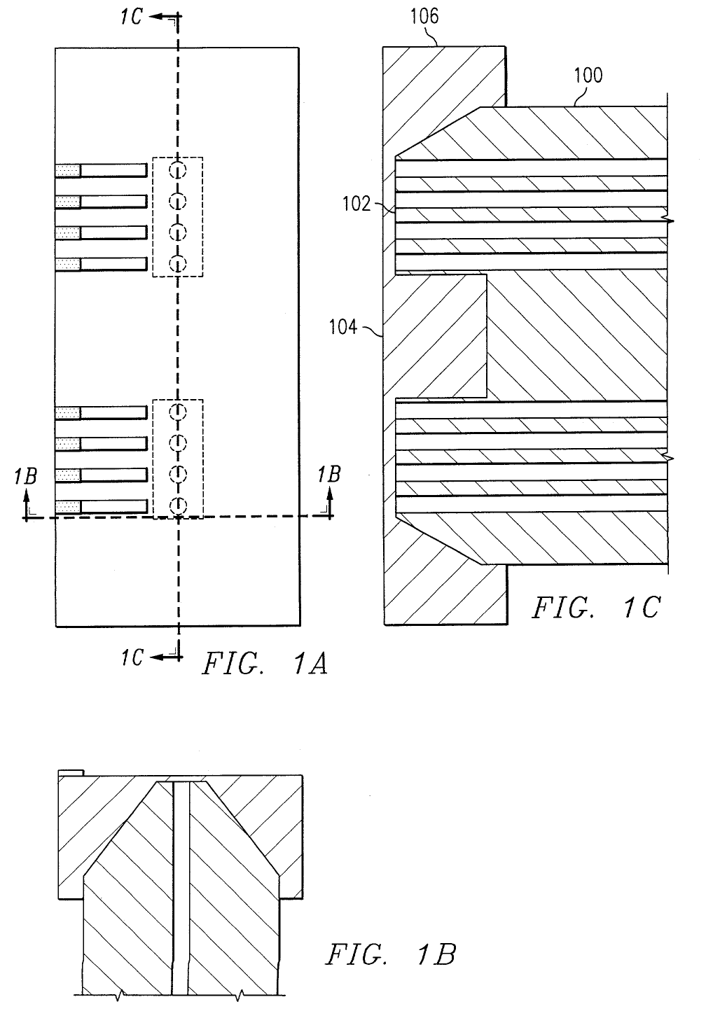

With reference now to FIG. 1, an exemplary illustration of a fiber optic holder/submount assembly after insertions of a fiber holder into the submount in accordance with a preferred embodiment of the present invention. Fiber holder 100 is inserted into a recessed side of submount 106 and anchored, for example, with an epoxy. In this operation of inserting fiber holder 100 into a recessed side of submount 106, end face 102 of the fiber holder may not be positioned so as to be coplanar with the face 104 of submount 106. End face 102 of fiber holder 100 may be retracted from being coplanar with face 104 of submount 106, for example, 50 to 100 microns in order to provide a small gap between the fibers and the optoelectronic chips in an axial direction. This retraction may be accomplished with a temporary stop. This temporary stop may be placed at face 104 of submount 106 during the fiber holder insertion process. However, no alignment in the lateral direction may be required. All that may be required in the lateral direction is a gap between the end of fiber holder 100 and the recesses of submount 106. A bonding agent, for example, an epoxy, may be placed in the gap between face 102 of fiber holder 100 and the recesses of submount 106 in order to attach fiber holder 100 and submount 106 to one another.

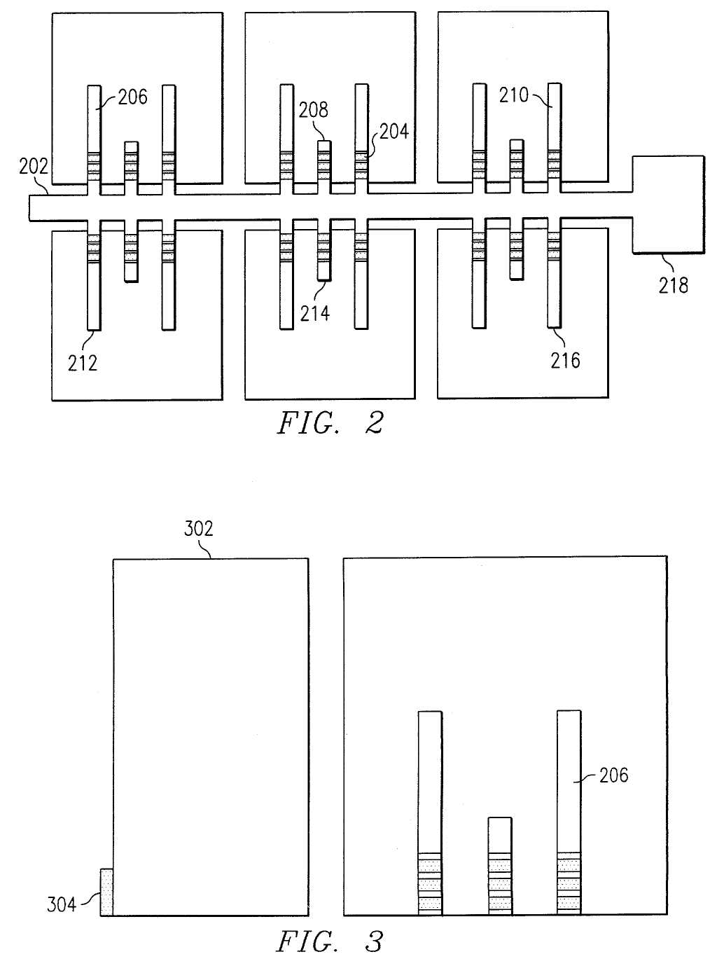

FIG. 2 is an exemplary illustration of a manufacturing process used in the fabrication of a silicon submount to be processed in wafer form in accordance with a preferred embodiment of the present invention. The first step in the fabrication process is to etch a silicon wafer area between individual submount outlines in an area reserved for a saw kerf. The etch creates an angled “step” on the edge of each discrete submount which will later be both photolithographically circuitized and gold plated to create a 90 degree electrical path. Note that this etched step may enable circuit traces (subsequently added to submount 106) to be in a plane above traces 206 and 208, yet maintain electrical continuity by virtue of the step. The next step in the process is to simultaneously create all needed electrical traces, for example, electrical traces 206, 208, 210, 212, 214 and 216 and associated pad 218, on the wafer using a standard photolithographic process. During the photolithographic process, conductor 202 in the kerf region between rows of chips is also created. The kerf region is the area where the chip is later sawed.

Conductive traces within the kerf area are used to electroplate, for example, gold on the corner of submount 104, whereby the wafer is immersed in an electroplating bath, contacts are made to traces in the kerfs, and the plated regions, such as, for example, plated region 204, is plated up to a thickness, such as, for example, 50-100 microns.

The submounts are next sawed apart to singulate them. The saw kerf edge comes up to, but does not actually impinge on a 90 degree gold plated turn, as to maintain the integrity of the electrical path around the corner between, for example, traces 206 and 202. These conductors are used to electrically connect to traces in the chips, for example, trace 206, and is connected in every other row of chips.

FIG. 3 is an exemplary illustration of a completed submount designed to accept an optoelectronic chip in accordance with a preferred embodiment of the present invention. In this example, thickened trace 304 has been thickened in the electroplated region to a thickness, for example, 50 to 100 microns. The optoelectronic chip may now be flip chip and wire bonded on submount 302.

The purpose of the thickened electroplated regions on thickened trace, for example, thickened trace 304, may be to provide good anchoring regions for soldering submount 302 on a circuit board. Traces on the circuit board may be provided with solder “bumps.” A solder bump may be, for example, evaporated or plated solder that is reflowed to create a hemispherical hump. Heat may then be applied to the thickened region, the solder bumps are melted, and submount 302 is lowered into the solder bumps so that solder “wets” the electroplated regions before solidifying. However, a metallurgy is chosen to permit the electroplated regions to be robust but solderable. A metallurgy which has these characteristics may be, for example, a layer of copper or nickel followed by a layer of gold.

During production, the typical accuracy for placement of a saw cut for slicing a wafer ranges, for example, approximately 2 to 20 microns. Because of this fact, sawing into electroplated layer 304 may damage the electroplated layer. Therefore, electroplated layer 304 may be designed to be displaced from a nominal chip edge by, for example, 20 microns. Since a solder bump on the circuit board is, for example, 100 to 300 microns in depth, electroplated layer 304 will nevertheless be immersed in solder.

While solder potentially provides a secure connection between submount 302 and a circuit board (not shown), a solder bond may not be adequate for mechanical integrity. For adequate mechanical integrity, an adhesive, for example, epoxy, may be applied to the connection between submount 302 and the circuit board to supply a robust fillet between submount 302 and the circuit board. The adhesive may be applied, for example, on opposite sides of submount 302 from the traces, such as, for example, electrical trace 206. Alternatively, electrically conductive materials other than solder, for example, conductive epoxies, may be used to provide the electrical connection between submount 302 and the circuit board.

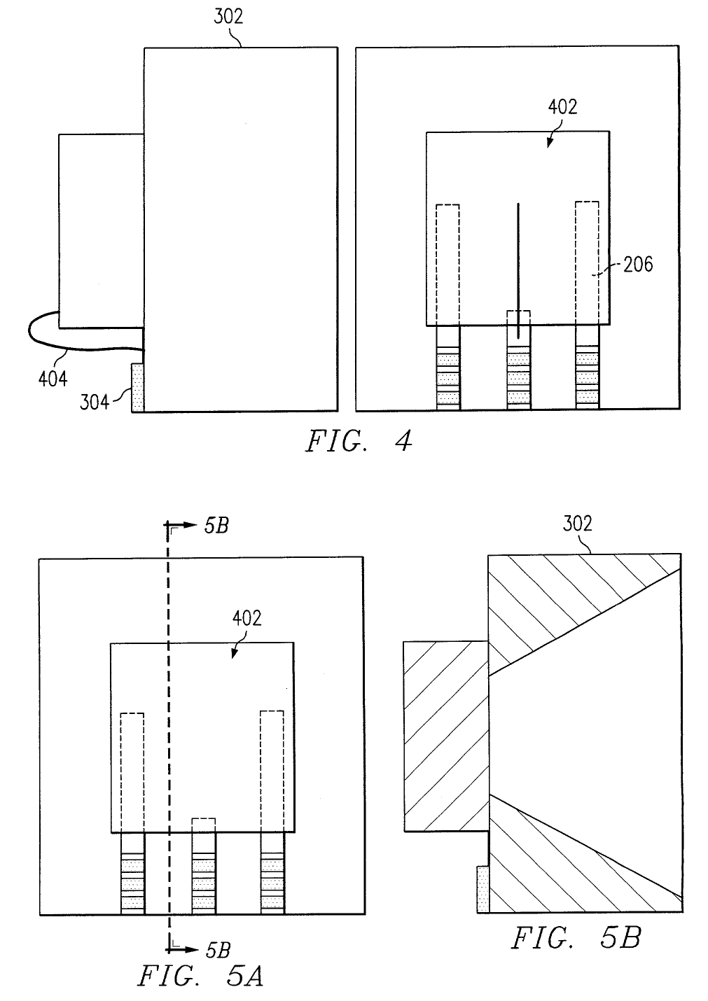

FIG. 4 is an exemplary illustration of flip chip bonding of an optoelectronic chip on a submount in accordance with a preferred embodiment of the present invention. In this example, an active-side up VCSEL chip 402 is shown flip-chip bonded to a substrate with single wire bond 404 between VCSEL chip 402 and submount 302 which may be required to connect a laser cathode to grounded trace 304. The active side of the VCSEL is where the circuitry and the laser are located. The bottom face of VCSEL chip 402, (i.e. the face contacting submount 302) represents an electrical terminal, whereas another VCSEL electrical terminal is on the top face of submount 302 and is accessible by wire bond 404. Light may be emitted from the top face of VCSEL chip 402 in a direction away from submount 302. A receiver chip (not shown) may be attached to submount 302 in a similar fashion, e.g. flip chip bonded, with the receiver chip's active face away from submount 302. One alternative method of mounting a laser and a photodetector to submount 302 is to use gold-tin reflux. This may allow the laser and the photodetector to be mounted in a more accurate coplanar fashion.

A flip-chip mounting may be advantageous because inductance associated with the wire bonds may be eliminated, thereby permitting achievement of higher data rates. However, since the silicon substrate is opaque at shorter wavelengths, such as 850 nanometers, often used in data communication applications, submount 302 may be modified to permit a free light path as illustrated in FIG. 5.

FIG. 5 is an exemplary illustration of a submount designed for flip-chip mounting of an optoelectronic chip in accordance with a preferred embodiment of the present invention. In this example, rectangular openings are etched in the silicon substrate and optoelectronic chips are mounted on submount 302 so as to straddle these rectangular openings.

A caustic solution may be used for etching. An example of the process for etching the rectangular openings in the silicon substrate for flip-chip mounting of an optoelectronic chip may be as follows. First, an inert base film, for example, silicon nitride, may be deposited on a front side of a wafer which may be the side for delineating traces. Then an etching mask film, for example, silicon nitride, is deposited on a back side of the wafer. The etching mask film is photolithographically patterned, as described in FIG. 2, to create the appropriate openings in the mask film for the etching. The required openings are etched in the silicon substrate. During this step, the inert base film may remain stretched over the openings on the front side of the wafer. The photolithographic pattern is traced on the front side of the wafer. Because of the presence of the inert base film, a photoresist may be applied for photolithography. However, a photoresist may not be applied for photolithography in the absence of the inert base film because the openings in the silicon substrate may impede the photoresist spin coating operation. The optoelectronic chip is then flip-chip bonded. After completion of the opening etching process, the inert base film may not need to be removed under the chips to provide a free optical path because of the transparent nature of the inert base film. In the present invention, etched opening positioning will ensure proper die bonding of the optoelectronic chip that allows for a free optical path.

If fiber guides are fabricated on the chips, the fiber guides may be accessible for fiber insertion either for VCSEL 402 active side up or VCSEL 402 active side down. In the VCSEL 402 active side down case, a fiber may be inserted into the fiber guide through an opening etched in the silicon substrate as described above. Then optoelectronic chip may be die bonded to submount 302.

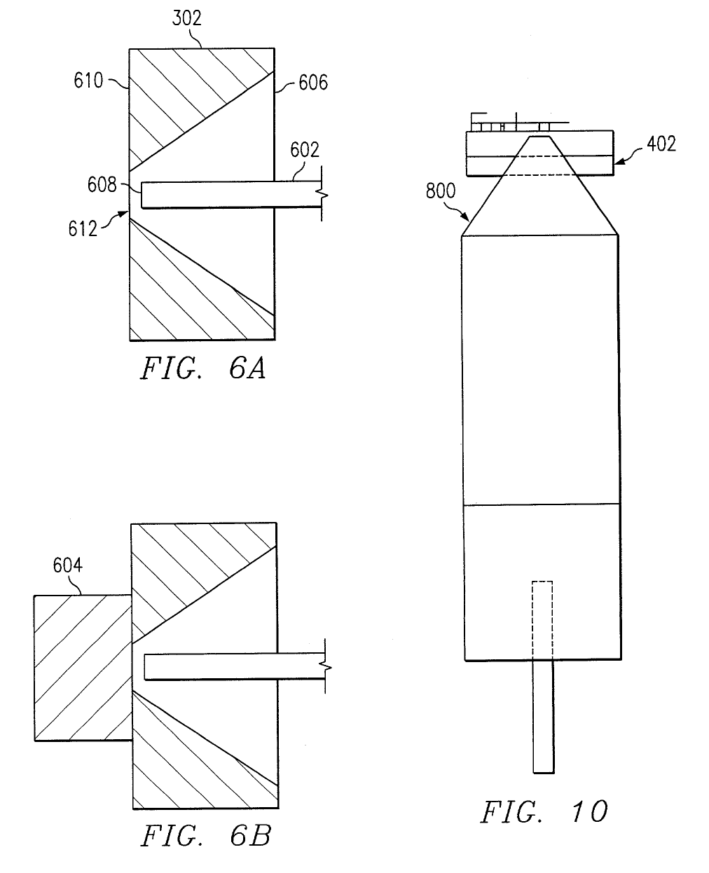

High precision, for example, 1 micron, production die placement tools are available for flip-chip bonding and these high precision production die tools may be used to place the optoelectronic chip precisely in position relative to the fiber. As such, a submount fabricated with an etched hole for flip-chip mounting as described above in FIG. 5 may be used. The procedure for placing the optoelectronic chip precisely in position relative to the fiber is described in FIG. 6.

FIG. 6 is an exemplary illustration of using a precision flip-chip die bonder to obtain passive alignment with an optoelectronic submount in accordance with a preferred embodiment of the present invention. In this example, fiber 602 is threaded into a hole in submount 302 from back side 606 of submount 302. Fiber 602 is pushed against a special temporary stop (not shown) so that forward end 608 of fiber 602 is not flush with front surface 610 of submount 302, but instead, is retracted from front surface 610 of submount 302 by, for example, 10 to 20 microns. Fiber 602 may be then attached to submount 302 with a suitable bonding agent, for example, an adhesive such as ultraviolet cross linked epoxy. After attaching fiber 602 to submount 302 the temporary stop is removed. Fiber 602 may be positioned near the center of hole 612 in submount 602 but it may not be necessary to align fiber 602 with respect to the sides of hole 612 in submount 302.

A circle may be an object for recognition and centroid determination by a machine vision system for placing fiber 602 into submount 602. End 608 of fiber 602 presents such an object for a vision system of a die placement tool. The outside diameter of fiber 602 may be used as a fiducial mark or alternatively visible light may be supplied into fiber 602 and the illuminated core of fiber 602 may be used for placing fiber 602 into submount 302. Corresponding marks which may be keyed to a position of optically active areas may be fabricated on optoelectronic chip 604. The flip-chip die placement tool then may be aligned with the supplied fiducial marks to the image of the forward end of fiber 602.

The procedure explained above in FIG. 6 has been devoted to alignment of a single fiber to a single optoelectronic element. However, these concepts may be extended to alignment of an array of fibers to an optoelectronic chip containing an array of optoelectronic elements, such as, for example, the laser apertures of the photodetector apertures. If the fiber guide procedure as explained above, is used, it is possible to insert and attach fibers sequentially into various fiber guides of an array chip. However, when cost is taken into consideration, it may be more cost effective to insert an array of fibers simultaneously into an array of fiber guides. If the fibers among the array of fibers are captured in a holder, such as, for example, an array of V-grooves etched in silicon, fiber spacing between the fibers in the array of fibers may be held within 1 micron. The optoelectronic elements on the chip may also be spaced accurately since the optoelectronic elements are made by a photolithographic means. If high precision of fiber spacing and optoelectronic elements are accomplished, then it may only be necessary to guide the fibers at either end of a fiber array into their respective fiber guides since the remaining fibers at either end of the fiber array will automatically be inserted correctly. Alternatively, as illustrated above in reference to a single fiber, a flip-chip procedure may be used for fiber arrays.

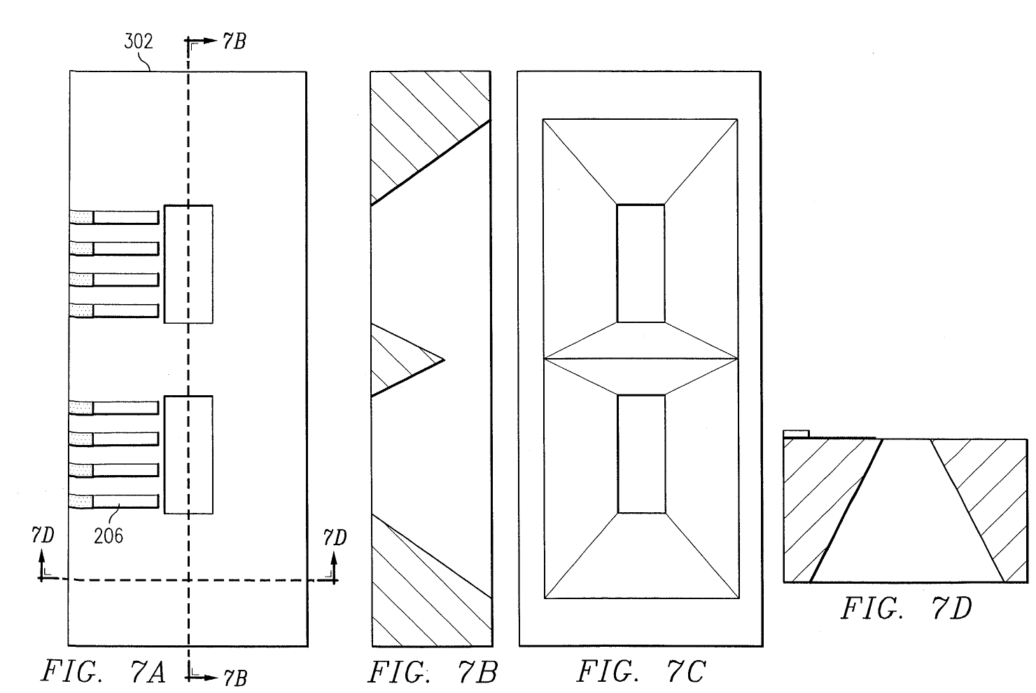

FIG. 7 is an exemplary illustration of a submount to be used with a fiber optic array in accordance with a preferred embodiment of the present invention. Flip-chip mounting of an VCSEL and a photodetector array will give the shortest electrical paths and, hence, the highest data rates. The VCSEL and the photodetector array chips may be mounted on an optoelectronic submount with the aid of a precision die bonder as explained above.

The optoelectronic submount 302 utilized for fiber array optical subassembly (OSA) is manufactured the same was as previously described above for a single channel OSA. A hole is required in the OSA and is etched, the signal carrying traces are photolithographically delineated on a silicon wafer, the ends of the traces are electroplated to provide an increased thickness, and the complete wafer is sliced to result in individual submounts, such as, for example, submount 302.

In this example, for a flip-chip alignment of arrays using a precision die placement tool, a rectangular opening in optoelectronic submount 302 may be needed in order to accommodate the fiber array light path. Submount 302 which may be used in the fabrication of a transceiver may have, for example, four transmitting channels at one end of submount 302 and, for example, four receiving channels at the other end of submount 302. A gap may be provided between the transmitting and receiving channels in order to decrease the occurrence of electrical crosstalk.

Etching techniques as described above are employed to fabricate submount 302. In addition, electrical traces, such as electrical trace 206, are delineated on submount 302 using the techniques described above. In this example, electrical traces are illustrated by two sets of four electrical traces for the two sets of four optoelectronic channels which may be one fiber and one laser or one fiber and one photodetector.

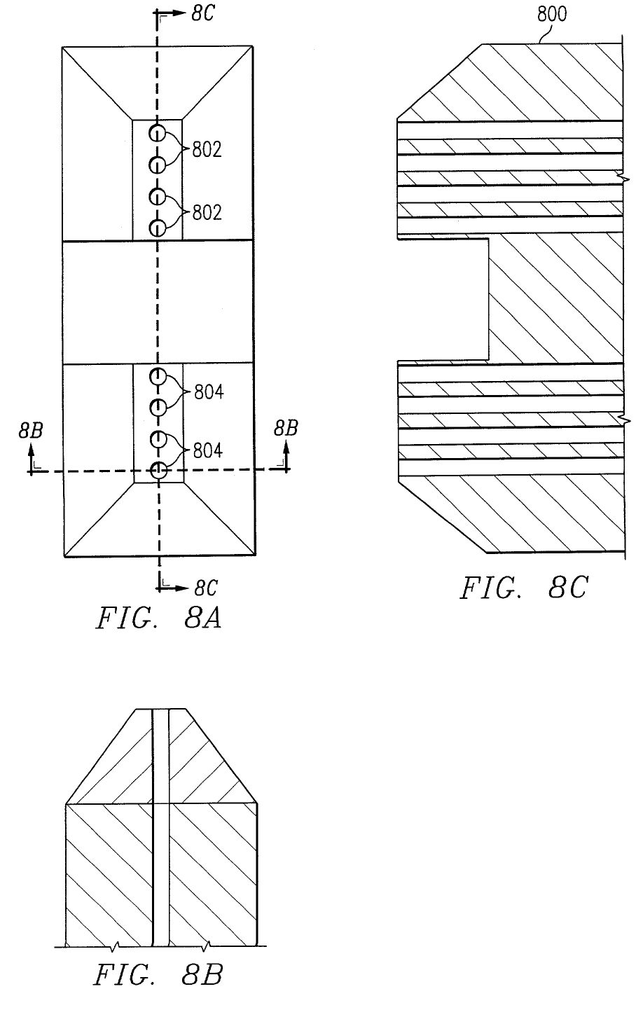

FIG. 8 is an exemplary illustration of a fiber optic end holder structure designed to mate with a submount in accordance with a preferred embodiment of the present invention. In this example, eight channel fiber holder 800 is illustrated. Fiber holder 800 may be designed to incorporate two sets of four fibers 802 and 804 while being mateable to submount 302 shown in FIG. 7. Fiber holder 800 may be fabricated by etching V-grooves in, for example, two pieces of silicon and anchoring fibers in the V-grooves, resulting in fiber arrays being sandwiched between, for example, the two pieces of silicon.

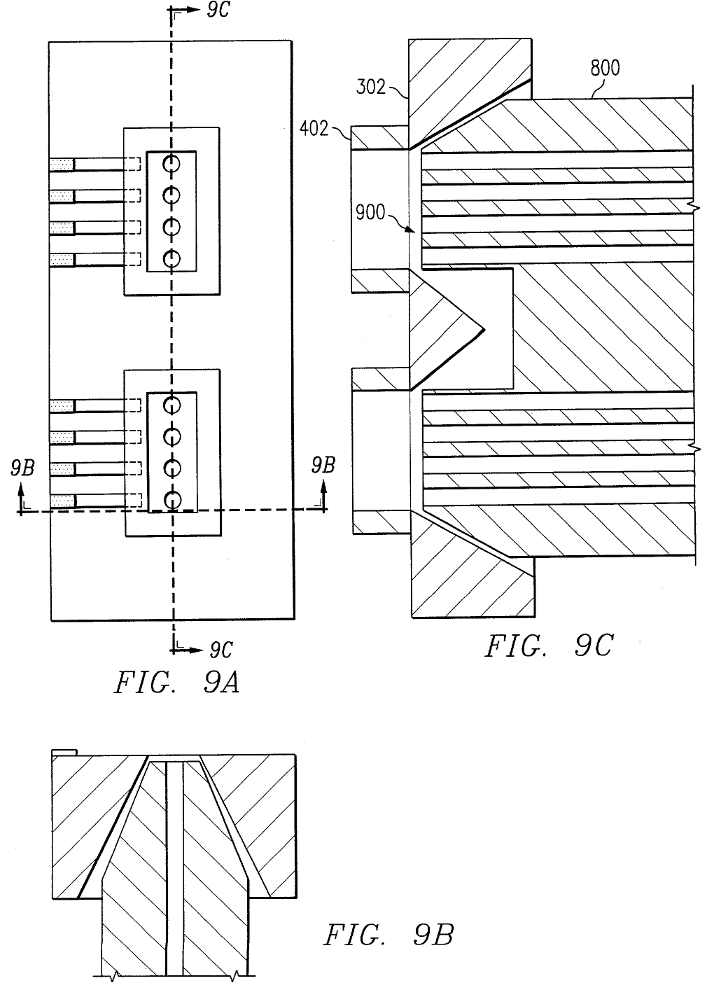

FIG. 9 is an exemplary illustration of a fully assembled submount with fiber optic holder and optoelectronic chips in accordance with a preferred embodiment of the present invention. In this example, gap 900, for example, a 75 micron gap, is provided between submount 302 face and fiber holder 800 face. The optoelectronic chip containing VCSEL 402 and photodetector are now flip-chip bonded on the fiber holder/submount assembly using a precision die bonder.

FIG. 10 is an exemplary illustration of a finished assembly of the fully assembled submount with fiber optic holder and optoelectronic chips incorporated into a circuit board in accordance with a preferred embodiment of the present invention. In this example, the fully assembled submount 402 with fiber holder 800 and optoelectronic chip, such as, for example, optoelectronic chip 604 in FIG. 6, are shown. As noted above, in FIG. 9, a precision die bonder may be used to flip-chip bond the electronic chips in the correct position on submount 302. For this purpose, a precision flip-chip bonder is used to view fiducial marks at two ends of each optoelectronic chip as well as the two end fibers, then aligning the chip with respect to the fiber array by means of a machine vision and die bonding the chip in place. An index-matching material, such as, for example, a gel or an epoxy, may be inserted into the small gap between the optoelectronic chip and the fiber faces. This index-matching material may serve to reduce the numerical aperture of the light, this, permitting a larger gap without coupling loss. Then the fully assembled submount is ready for incorporation into the next level of packaging, such as, for example, on a circuit board. During incorporation, the assembled submount is held firmly above the circuit board in an appropriate position. The traces of the submount are then soldered to pads provided on the circuit board. Mechanical support of the assembly may then be provided by attaching fiber holder 800 to the circuit board, with a bonding agent, such as, for example, epoxy.

Therefore, the present invention method and system for fabricating an optical subassembly (OSA) associated with the transmitting or receiving function by using a special optoelectronic submount incorporating a 90 degree turn for a multiple channel fiber array so that each transmission and reception carries an array of VCSELs and an array of photodetectors, respectively. The optoelectronic submount provides for a simple, compact assembly containing a small number of components. Incorporation of materials of similar composition is provided thereby reducing misalignment at elevated temperature originating in differences in thermal expansion coefficients. Good heat dissipation is provided through the silicon substrate of the submount. Utilization of short traces are suitable for operation as a high data rate. Additionally, the optoelectronic submount results in low fabrication and manufacturing cost.

The description of the present invention has been presented for purposes of illustration and description, but is not limited to be exhaustive or limited to the invention in the form disclosed. Many modifications and variations will be apparent to those of ordinary skill in the art. The embodiment was chosen and described in order to best explain the principles of the invention, the practical application and to enable others of ordinary skill in the art to understand the invention for various embodiments with various modifications as are suited to the particular use contemplated. While the invention has been particularly shown and described with reference to a preferred embodiment, it will be understood by those skilled in the art that various changes in form and detail may be made therein without departing from the spirit and scope of the invention.

What is claimed is:

1. An optical subassembly, comprising:
a mounting structure having a plurality of angled conductive traces disposed on a first surface of the mounting structure;
a holding device, coupled to a second surface of the mounting structure, having a plurality of optical channels; and
a laser optical device electrically connected to the conductive traces on the mounting structure,
wherein an optical signal emitted or received by the laser optical device is converted to an electrical signal and the electrical signal is transmitted by way of the plurality of angled conductive devices to the plurality of optical channels.

2. The optical subassembly in claim 1, wherein the plurality of angled conductive traces includes a ninety degree angle.

3. The optical subassembly in claim 1, wherein the mounting structure is constructed of silicon.

4. The optical subassembly of claim 1, wherein the plurality of angled conductive traces are electroplated to a selected thickness.

5. The optical subassembly of claim 4, wherein the selected thickness is about 50 microns to 100 microns.

6. The optical subassembly in claim 4, wherein the plurality of angled conductive traces are electroplated includes at least one of a layer of copper and a layer of nickel followed by a layer of gold.

7. The optical subassembly in claim 1, wherein the laser optical device is electrically connected to the conductive traces on the mounting structure by flip chip bonding.

8. The optical subassembly of claim 1, wherein the plurality of optical channels is two sets of four optical channels.

9. The optical subassembly of claim 1, the holding device, further comprising:
a set of v-grooves, wherein the set of v-grooves anchor a fiber array within the holding device.

10. The optical subassembly of claim 1, wherein the holding device is coupled to the mounting structure, wherein a surface of the holding device is coupled to the second surface of the mounting structure and a predetermined distance is between the surface of the holding device and the second surface of the mounting structure.

11. The optical subassembly of claim 10, wherein the predetermined distance between the surface of the holding device and the second surface of the mounting structure is about 75 microns.

12. The optical subassembly of claim 1, further comprising:
inserting a fiber array into the holding device; and
attaching the fiber array to the mounting structure.

13. A method of fabricating conductive traces on a mounting structure for an optical subassembly, comprising the steps of:
patterning a photoresist mask onto a first surface of the mounting structure to define locations of circuit traces, wherein the circuit traces are a plurality of angled circuit traces;
etching the first surface in the presence of the photoresist mask to form a plurality of angled circuit traces in the mounting structure; and
bonding a first layer of a conductive material to the circuit traces.

14. The method of claim 13, wherein the plurality of angled circuit traces include a ninety degree angle.

15. The method of claim 13, wherein the first layer of conductive material is at least one of copper and nickel.

16. The method of claim 13, further comprising:
bonding a second layer of conductive material to the circuit traces.

17. The method of claim 16, wherein the second layer of conductive material is gold.

18. A system of fabricating conductive traces on a mounting structure for an optical subassembly, comprising:
patterning means for patterning a photoresist mask onto a first surface of the mounting structure to define locations of circuit traces, wherein the circuit traces are a plurality of angled circuit traces;
etching means for etching the first surface in the presence of the photoresist mask to form a plurality of angled circuit traces in the mounting structure; and
bonding means for bonding a first layer of a conductive material to the circuit traces.

19. The system of claim 18, wherein the plurality of angled circuit traces include a ninety degree angle.

20. The system of claim 18, wherein the first layer of conductive material is at least one of copper and nickel.

21. The system of claim 18, further comprising:
bonding means for bonding a second layer of conductive material to the circuit traces.

22. The system of claim 21, wherein the second layer of conductive material is gold.
